(19) United States
(12) Patent Application Publication
(10) Pub. No.: US 2014/0006067 A1
(43) Pub. Date: Jan. 2, 2014

(54) TRAVEL EXPENSE OPTIMIZER

(71) Applicants: Martina Rothley, Schwetzingen (DE); Johann Kemmer, Muehlhausen (DE)

(72) Inventors: Martina Rothley, Schwetzingen (DE); Johann Kemmer, Muehlhausen (DE)

(73) Assignee: SAP AG, Walldorf (DE)

(21) Appl. No.: 13/534,889

(22) Filed: Jun. 27, 2012

(51) Int. Cl. G06Q 10/02

(52) U.S. Cl. 705/5

(57) ABSTRACT

A method includes electronically searching for pricing and availability of travel components for a trip requested by an employee of an organization. The travel plan is optimized for cost and conformance to travel policies and rules of the organization by selecting travel components for the trip using a microprocessor-based solution. The optimized travel plan is presented on an interactive interface with decision tools to an agent of the organization for approval or automatic re-optimization with current pricing and availability of the travel components for the trip. Financial reports on cost savings achieved by optimization and re-optimization of the travel plans by organization and its units are presented.

### BACKGROUND

Electronic travel and expense (T&E) management solutions allow a business organization or other entity to automate some travel and expense management processes, for example, booking travel and reimbursing employees. Employees of the organization can make individual travel arrangements for trips and submit individual travel expense reports through these automated solutions for reimbursement.

An organization or entity may be structured in units and sub-units (e.g., cost centers, project teams, departments, divisions, etc.) (hereinafter “sub-entities”). Consideration is now being given to solutions that allow organizations to manage travel planning and travel costs at an organizational sub-entity level.

### SUMMARY

A travel plan for a trip includes one or more travel components, for example, long distance transportation, local transportation, accommodations, etc., that may be used for the trip.

In one general aspect, a system optimizes travel plans for trips by employees at cost center, team, department, division or other sub-entity level of an organization. The system groups employees and provides an overview of their travel plans at the sub-entity level. The system has a travel plan approval process for a trip of an employee, which involves providing an approver with comparative information including cost information on similar travel plans or trips by other employees, for example, at cost center, team, department, division or other sub-entity level of the organization. The system includes reporting on cost savings realized by optimizing travel plans for trips by employees at cost center, team, department, division or other sub-entity level of the organization.

In another general aspect, a computer-hosted travel-management solution prepares and automatically optimizes travel plans for trips by individuals of an organization. The travel plans are optimized to reduce travel costs and to conform to the organization's travel policies and rules. The solution also provides supervisory functions and tools for decisions on individuals' travel plans.

In another aspect, the computer-hosted travel-management solution includes functions and features that allow authorized users (e.g., travel planners or agents) to review, optimize or re-optimize the travel plans for trips by individuals. The travel plans can be optimized or re-optimized individually or in groups with common characteristics such as common destination, department and/or cost center, etc. The optimized or re-optimized travel plans are presented to approvers for approval.

In a general aspect, a microprocessor-based system includes a travel plan optimizer hosted on a computer. The travel plan optimizer is coupled to a repository of travel policies and rules of an organization and a unit configured to obtain market data on travel components of a travel plan for a trip by a person of the business organization.

In response to receiving a travel request for the trip by the person of the business organization, the travel plan optimizer optimizes the travel plan for the trip by automatically selecting travel components with consideration of costs of individual travel components, a total cost of travel components and conformance of the travel components to the travel policies and rules of the organization. The travel plan optimizer evaluates alternate modes of transportation, alternate modes of accommodation, alternate routes and alternate start and end dates for the trip for inclusion in the optimized travel plan. The travel request optimizer can group the trip by the person with trips by other personnel of the organization to avail of group rates for services.

In a further aspect, the microprocessor-based system includes a first interactive interface for receiving a travel request for a trip by a person of the business organization and a second interactive interface for supervision of optimized travel plans by an agent of the business organization. A decision tool provides a list of optimized travel plans of organization personnel via the second interactive interface to the agent of the business organization. The decision tool includes functionality to initiate automatic re-optimization of the group of optimized travel plans but allows also for manual interaction to optimize travel plans of a group of employees. A financial reporting tool generates financial reports showing costs savings realized by travel plan optimization for different organizational sub-entities (e.g., cost centers, teams, departments, divisions etc.).

In a general aspect, a method includes electronically searching for pricing and availability of travel components for a trip by a particular employee of an organization, and optimizing a travel plan by selecting low or lower cost travel components for the trip using a microprocessor-based solution. The method further includes presenting the optimized travel plan for the particular employee's trip to an agent of the organization, and re-optimizing the travel plan for the particular employee's trip using current information on the travel components for the trip.

In another aspect, the method includes presenting the optimized travel plan for the particular employee's trip to an approver along with a group of other travel plans that share a common characteristic and automatically re-optimizing the presented travel plans individually or in groups using the microprocessor-based travel management solution.

In a further aspect, the method includes generating at least one financial report on the organization or a sub-entity's travel costs and cost savings obtained by the optimization or re-optimization of travel plans.

In a general aspect, a non-transitory computer readable medium includes instructions capable of being executed on a microprocessor. The instructions when executed, electronically search for pricing and availability of travel components for a trip by a particular employee of an organization and optimize a travel plan for the particular employee's trip by selecting travel components for the trip with consideration of individual travel component cost, a total cost of all travel components for the trip, and the organizations' travel policies and rules. Upon reviewing by an agent of the optimized travel plan for the particular employee's trip, the instructions when executed further re-optimize one or more groups of travel plans using current information on the travel components. The travel plans that are re-optimized are may be grouped by common destination, by common destination and department or sub-entity, and by common employee of the organization. The instructions when executed generate at least one financial report on travel costs and cost savings obtained with the optimization or re-optimization of travel plans by the organization or a sub-entity (e.g., a cost center, team, department, etc.).

The details of one or more implementations are set forth in the accompanying drawings and the description below. Further features of the disclosed subject matter, its nature and various advantages will be more apparent from the accompanying drawings, the following detailed description, and the claims.

### BRIEF DESCRIPTION OF THE DRAWINGS

FIGS. 1 and 2 are schematic illustrations of a microprocessor-based system for travel planning and for managing travel costs of a business organization or other entity, in accordance with the principles of the disclosure herein.

FIGS. 3A-3C are schematic illustrations of an example interactive screen of the system of FIGS. 1 and 2, which is customized for use by an individual employee of the business organization or other entity, in accordance with the principles of the disclosure herein.

FIGS. 4A and 4B are schematic illustrations of an example interactive screen of the system of FIGS. 1 and 2, which is customized for use by an agent of the business organization or other entity, in accordance with the principles of the disclosure herein.

FIGS. 5A and 5B are schematic illustrations of an example interactive screen of the system of FIGS. 1 and 2, which is customized for use by a supervisor or manager of the business organization or other entity, in accordance with the principles of the disclosure herein.

FIG. 6 is a flow diagram illustrating an example method for optimizing a travel plan for a trip by a person of a business organization or other entity, in accordance with principles of the disclosure herein.

### DETAILED DESCRIPTION

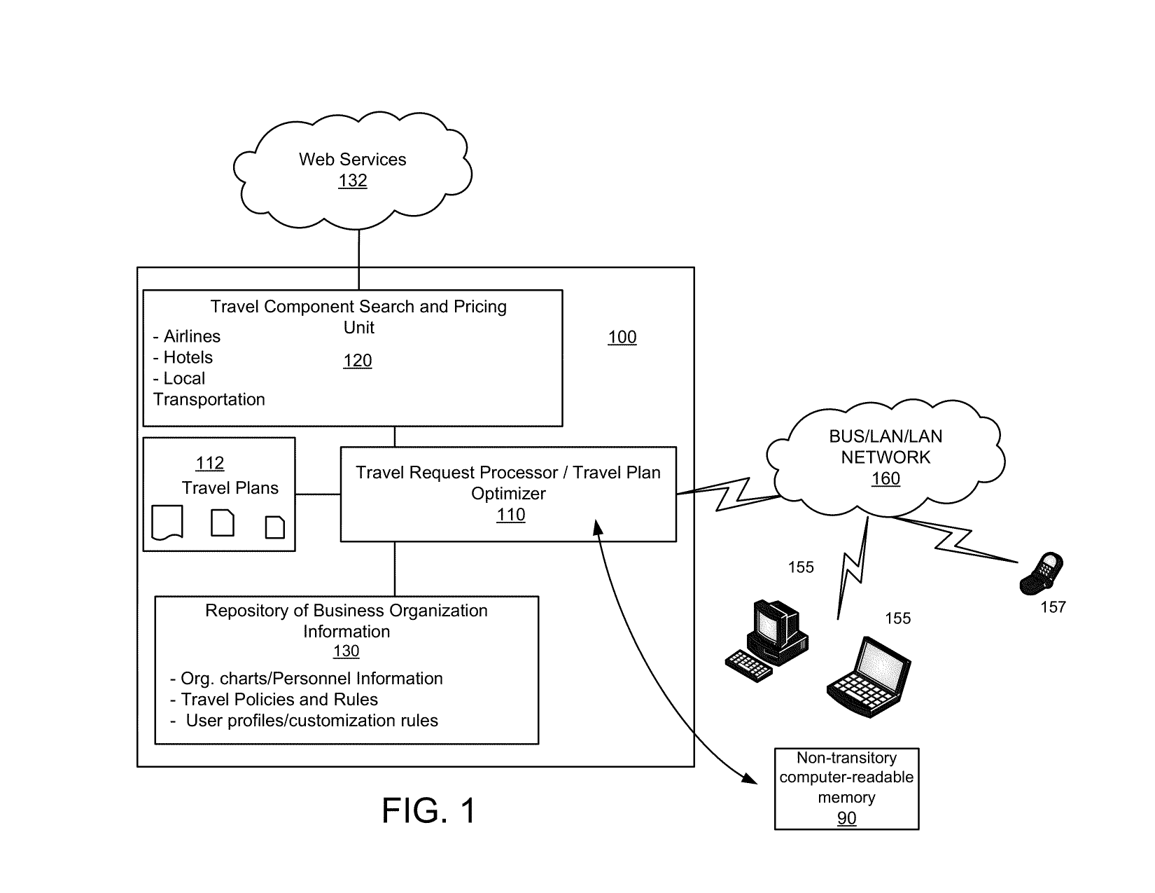

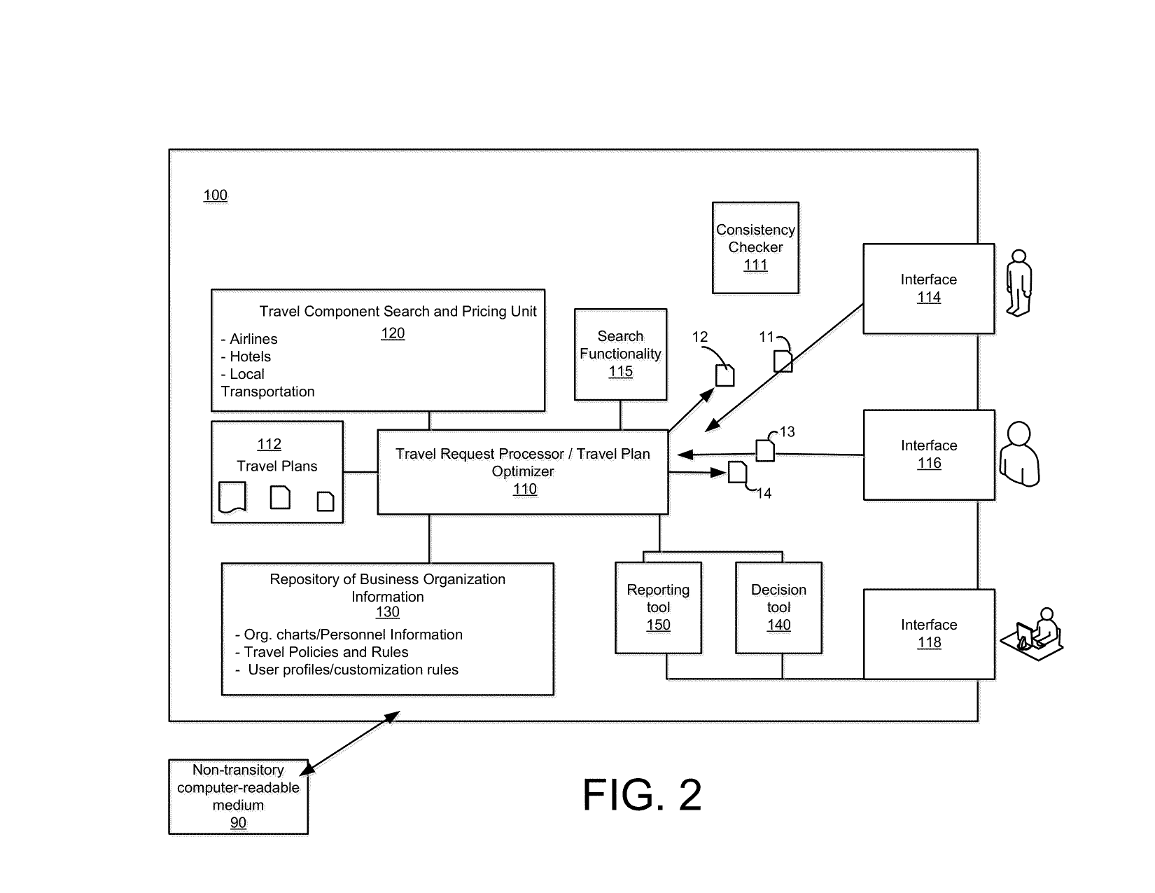

FIGS. 1 and 2 show a system 100 for travel planning and for managing travel costs of a business organization or other entity. The business organization may be arranged by sub-organizations or sub-entities (e.g. cost centers, teams, departments, divisions, etc.). System 100 may be configured to prepare travel plans that are optimized for cost and which conform to travel policies and rules of the business organization. System 100 may reduce travel costs incurred by the business organization or other entity for trips by the organization's personnel.

System 100 may provide travel planning support to personnel of the business organization by processing a travel proposal or request from individual personnel to prepare an optimized travel plan for that individual. System 100 may prepare the travel plan to conform to the business organization's travel policies and rules, and with a view to reduce travel costs. System 100 may be further configured to allow authorized agents (e.g., a travel agent) to manage the travel plans of one or more personnel. System 100 may allow the travel agent to review and modify (e.g., optimize or re-optimize) the travel plans of individuals for further travel cost reductions and to ensure that the travel plans conform to the business organization's travel policies or rules. System 100 may also provide a decision tool for supervisory approval or disapproval of the travel plans. The decision tool may enable an authorized agent (e.g., a supervisor or manager) who, for example, has supervisory authority for a travel budget of the business organization or a sub-entity, to manage the travel budget of the business organization or its sub-entity. System 100 may also include a financial reporting function, which can provide financial reports on travel costs of the business organization and its sub-entities (e.g. a cost center, team, department, division, etc.), and information on realized or potential cost savings obtained from optimizing the travel plans.

As shown in FIG. 1, system 100 may include a travel request processor/travel plan optimizer 110 coupled to a repository 130 of business organization information and a travel component search and pricing unit 120. Repository 130 may include organization charts, travel policies and rules and other information related to the business organization that may be relevant to travel planning. Travel component search and pricing unit 120 may be configured to electronically obtain and provide market data (e.g., price and availability, etc.) for travel plan components (e.g. airlines, accommodation, local transportation, etc.). Travel request processor 110 may also be coupled to a repository 112 of travel plans for past, current or proposed trips by the organization's personnel.

System 100 may be hosted on one or more physical or virtual hosts on a computer network and may be accessible to users via one or more user devices (e.g., computing devices 155, smart phone 157, etc.) that may be wire or wirelessly linked (e.g., via BUS/LAN or WLAN networks 160) to travel request processor 110. A user may, for example, submit a travel proposal or request (e.g., request 11, FIG. 2) for an individual's trip to travel request processor 110 via BUS/LAN or WLAN network 160. Similarly, travel pricing unit 130 may be connected via wire or wireless links (e.g., Internet search engines, web services 132, etc.) to public or private sources of market data on travel component availability and pricing.

As shown in FIG. 2, system 100 may include additional components and features. System 100 may include one or more interactive user interfaces that may be customized according to different user-roles in the business organization. System 100 may, for example, present one type of interface (e.g., interface 114) for interaction with an individual traveler, a second type of interface (e.g., interface 116) for supervision of travel plans by a travel agent or planner, and a third type of interface (e.g., interface 118) for supervision of travel plans by a supervisor or manager in the business organization.

It will be understood that one or more components or features of system 100 (e.g., travel request processor 110, travel component search and pricing unit 120, decision tool 140, interfaces 112-118, etc.) may be implemented via instructions stored in non-transitory computer-readable memory.

Travel request processor 110 may be configured to process a travel request or proposal for a trip by an individual and to prepare or assist in preparing an optimized travel plan for that individual's trip.

Travel request processor 110 may receive a travel request or proposal 11 for the individual's trip, for example, submitted via interface 114 by a user. Travel proposal 11 may, for example, include information such the origin, destination and proposed start and return dates of the trip. Travel proposal 11 may also include the individual traveler's preferences or choices for various travel components (e.g., transportation modes, accommodations, and travel routes) for the trip.

Travel request processor 110 may automatically consider each individual travel component and aspect (transportation, accommodations, routes, start and end dates, etc.) of the trip for preparing a travel plan 12 for the individual's trip. Travel request processor 110 may evaluate the various travel components of the proposed trip under different scenarios and consider alternates. For example, travel request processor 110 may evaluate alternate modes of transportation (e.g., air, rail, bus, etc.) for travel to and from the proposed origin and destination of travel and for local travel. Travel request processor 110 may use travel pricing unit 120 to obtain price and availability data for the alternate modes of transportation. Travel processor 110 may prepare travel plan 12 for the individual's trip by selecting a transportation component (e.g., rail) with consideration, for example, of economy, convenience and/or purpose of the trip. Further, travel processor 110 may consider the business organization's travel policies and rules (e.g., with reference to repository 130) in selecting the transportation component of the travel plan. Travel request processor 110 may, for example, similarly evaluate and select or suggest alternate modes of accommodation (e.g., hotel, guest house, etc.) at the destination, alternate routes to and from the destination, and alternate start and end dates for the trip, etc.

In preparing travel plan 12 for the individual's trip by considering each travel component of the trip and selecting or suggesting alternates, travel request processor 110 may, for example, review travel plans for trips by other organization personnel, which may be stored in repository 112. Travel request processor 110 may consider consolidation or grouping the individual's trip with similar trips proposed or planned by other personnel of the organization to benefit from economies of scale or to avail of group rates for services. Economies of scale may be achieved, for example, because service providers (for hotels, shuttle service, etc.) often provide discounted group rates based on the size of a traveling group. Economic group rates may be available, for example, for booking one shuttle service to transport a group of individuals instead of booking separate shuttle services for each individual. Travel request processor 110 in seeking economies of scale may consider consolidating trips that have been proposed or planned by other personnel of the organization in about the same time frame, to the same destination or event, or for the same purpose as the individual's trip. Further, travel request processor 110 may refer to organization information (e.g., organization charts stored in repository 130) to identify organization personnel belonging to the same organization sub-entity (e.g., cost center, team, department, division, etc.) as the individual and accordingly consolidate or group travelers together for economies of scale.

Further, in preparing travel plan 12 by considering each travel component of the trip and selecting or suggesting alternates, travel request processor 110 may also consider conforming each travel component of the trip to the organization's rules, policies and contracts with service providers or vendors (e.g., with reference to repository 130). The organization's travel policy may, for example, because of dual sourcing and sustainability considerations or initiatives, require selection of a service provider or vendor from an approved vendor list. Corporate contracts with service providers or vendors (e.g., hotels, shuttle service, etc.) may include quotas, targets in quantity or amount, scaled prices, etc.

System 100 may further include comprehensive search functionality 115 for all travel components (e.g., transportation, accommodation, time etc.) for the trip, which may allow a user to manually make individual choices of travel components to self-construct, or modify travel plan 12. The user may access search functionality 115, for example, via interface 114 to search for options for a particular travel component (e.g., airline flights). Search functionality 115 may rank search results for the particular travel component according to its individual cost. A cost of a travel component in a travel plan for a trip may be dependent on other components in the travel plan for the trip (e.g., a cheaper but earlier airline flight may result in higher costs for accommodation). Accordingly, search functionality 115 may also rank search results for the particular travel component by a total cost of the trip to account for interactions between choices of travel components made by the user.

System 100 may also include a consistency checker 111, which may be configured to automatically perform checks on a travel plan (e.g., a self-constructed or modified travel plan 12 for the individual's trip) prepared by a user. Consistency checker 111 may check if the travel components in the travel plan (e.g., travel plan 12) have costs that are as low as possible or available. Consistency checker 111 may, for example, consider if the individual has a travel reward or bonus account (e.g., an airline frequent flier card or a hotel reward card) which might be used to lower costs for a travel component. Consistency checker 111 may also consider compliance to requirements of organization rules and policies, which may not relate to lowering costs. For example, the business organization may have a disaster-planning or risk-mitigation rule forbidding more than one board member from travelling together on a same airline flight. In such instance, consistency checker 111 may check compliance with the disaster-planning or risk-mitigation rule and flag the travel plan (e.g., travel plan 12) if it violates the rule.

A cost of a travel component in a trip may be dependent on other travel components of the trip (e.g., a cheaper but earlier airline flight may result in higher costs for accommodation). Travel request processor 110 may be configured to automatically calculate possible costs of each of individual travel component and the combined cost of all travel components in travel plan 12.

System 100 may provide tools for cost analysis and compliance checking of the travel plans of individuals in the organization to authorized agents (e.g., a travel agent or travel expense department personnel), for example, via interface 116 and/or interface 118. An authorized agent may, for example, view or analyze travel plans for past, current or proposed trips by organization personnel, which may be stored in repository 112.

Interfaces 116 and 118 may provide system 100 functions to the authorized agent that are the same or similar to functions (e.g., travel request processor 110, search functionality 115, consistency checker 111, etc.) provided through interface 114 to a user for preparing a travel plan (e.g., travel plan 12) for an individual's trip. The authorized agent may prepare a travel plan (e.g., travel plan 14) for an individual's trip by submitting a travel proposal (e.g., travel proposal 13) to travel request processor 110, for example, via interface 116 in the same manner described above with respect to travel plan 12 prepared by the user via interface 114 The authorized agent may, for example, let travel request processor 110 automatically prepare travel plan 14 or use search functionality 115 to manually select one or more travel components of travel plan 14.

Further, an authorized agent may resubmit an individual's travel plan (e.g., self-constructed or modified travel plan 12) for reprocessing by system 100 to verify that the travel components in the plan are based on proper cost considerations and comply with the organizations' policies and rules. The authorized agent may also utilize consistency checker 111 to detect anomalies in the travel plan (e.g., the individual may have access to a company car, but the travel plan may list use of a private car).

System 100 may further provide tools for supervision of the travel plans of individuals in the organization to authorized agents (e.g., a supervisor or manager), for example, via interface 118. As noted previously, interface 118 like interface 116 may be configured to allow authorized agents to manually modify the travel plan for the individual's trip by considering each travel component of the trip. Interface 118 may provide access to system 100 functions (e.g., travel request processor 110, search functionality 115, consistency checker 111, etc.) for considering each travel component of the trip and selecting or suggesting alternates, as described above with respect to interfaces 114 and 116.

Interface 118 may also include a decision tool 140, which may be configured to implement an intelligent approval procedure for travel plans. For the intelligent approval procedure, system 100 may provide an overview of organization personnel and their travel plans the supervisor or manager, for example, via interface 118. The overview may enable the supervisor or manager to visually compare travel plan costs for an individual's trip with travel plan costs for similar trips by other individuals, and accordingly use decision tool 140 to approve, disapprove, or return for revision, the travel plan for the individual's trip. Decision tool 140 may be accessed by a supervisor or manager to review and approve (or disapprove) the travel plans of individuals. The decision tool may help an authorized agent (e.g., a supervisor or manager) who has supervisory authority for a travel budget of the business organization or a sub-entity (e.g. a travel budget of a cost center, team, department, division, etc.) to manage the travel budget of the business organization or its sub-entity.

System 100 may further include a reporting tool 150, which may be configured to generate financial reports based on the travel plans of individuals in the organization. A financial report may show cost savings realized by system 100's travel plan optimization procedures using different metrics (e.g., means of transportation, accommodation, etc.). Reporting tool 150, which may be accessible through interface 118, may be configured to generate financial reports for different organization entities (e.g., cost centers, teams, departments, divisions, etc.) and covering different time-periods (e.g., monthly, quarterly, annually, etc.). The financial reports may aid management of travel budgets in the organization.

In some versions of system 100, travel plan preparation processes may be user-customizable. System 100 may be configured to allow users to customize or personalize travel plan preparation and optimization processes by preselecting travel component preferences, for example, via a customization option displayed on interfaces 114-118. The customization option may offer a set of standard optimization rules for pre-selection by a user. Example standard optimization rules may include “as fast as possible” for route selection, “lowest cost,” “lowest cost but no overnight flights,” etc. Further, example standard optimization rules may include acceptable price ranges for travel components (e.g., hotels, flights, etc.). The standard optimization rules may also allow for extending trip duration, for example, to include weekends at the start and/or end of the trip. The standard optimization rules may incorporate and be consistent with organization's travel policies and rules. The standard optimization rules that are pre-selected by a user may be stored in a “user profile” (e.g., in repository 130) for current or future use by system 100 for personalized travel plan preparation for the user.

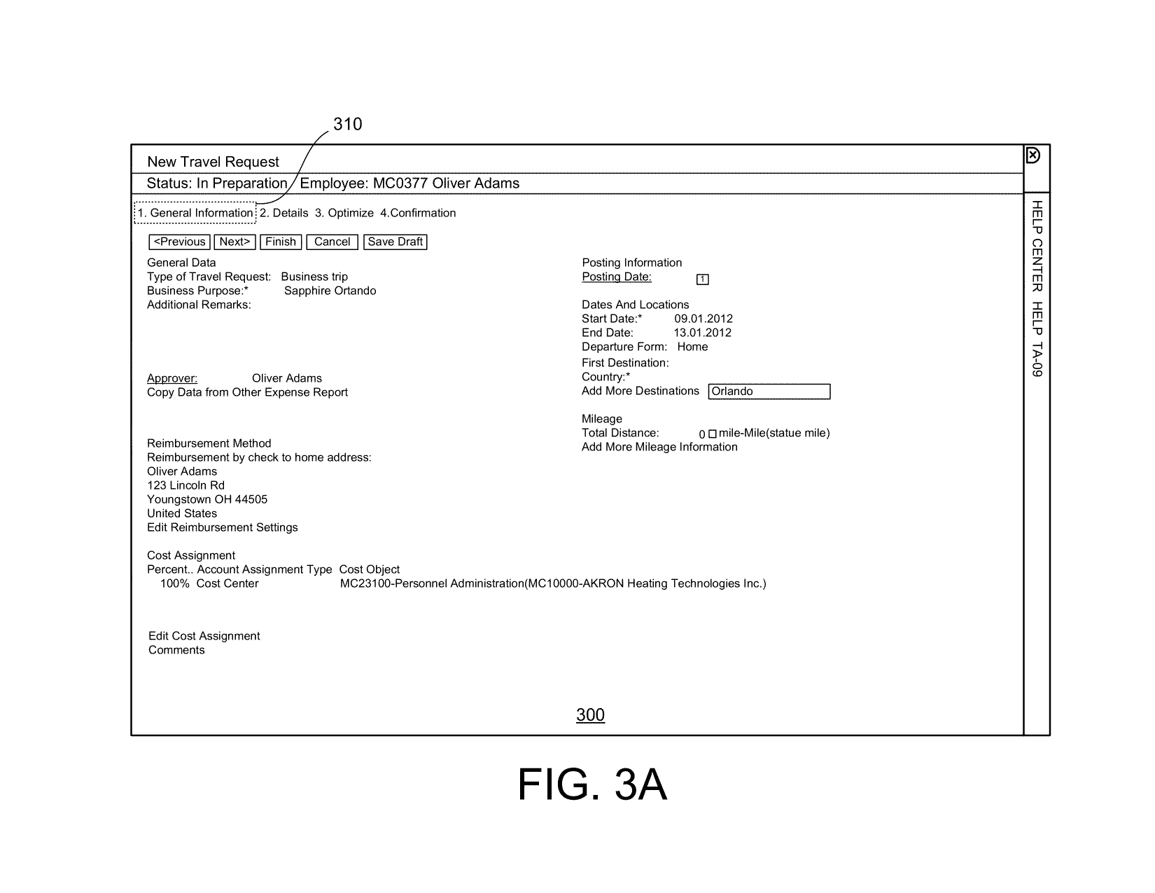

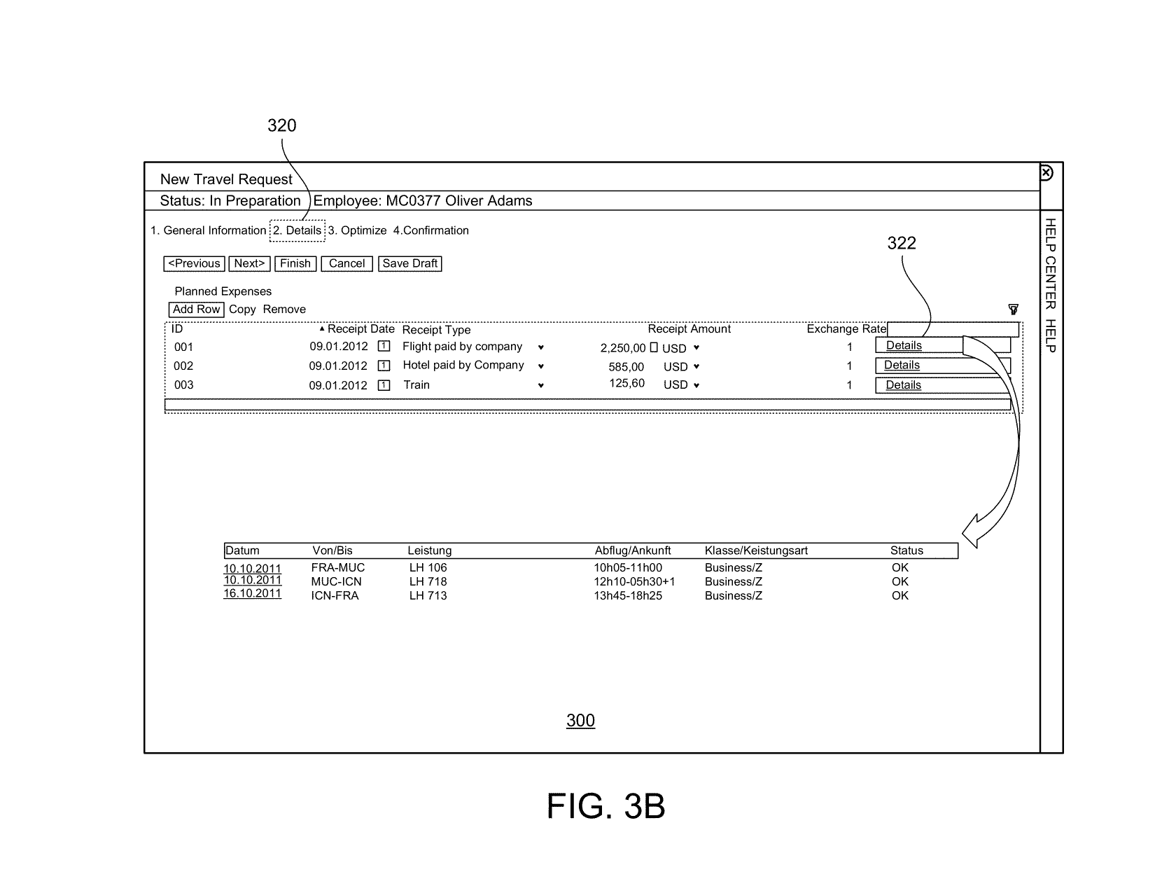

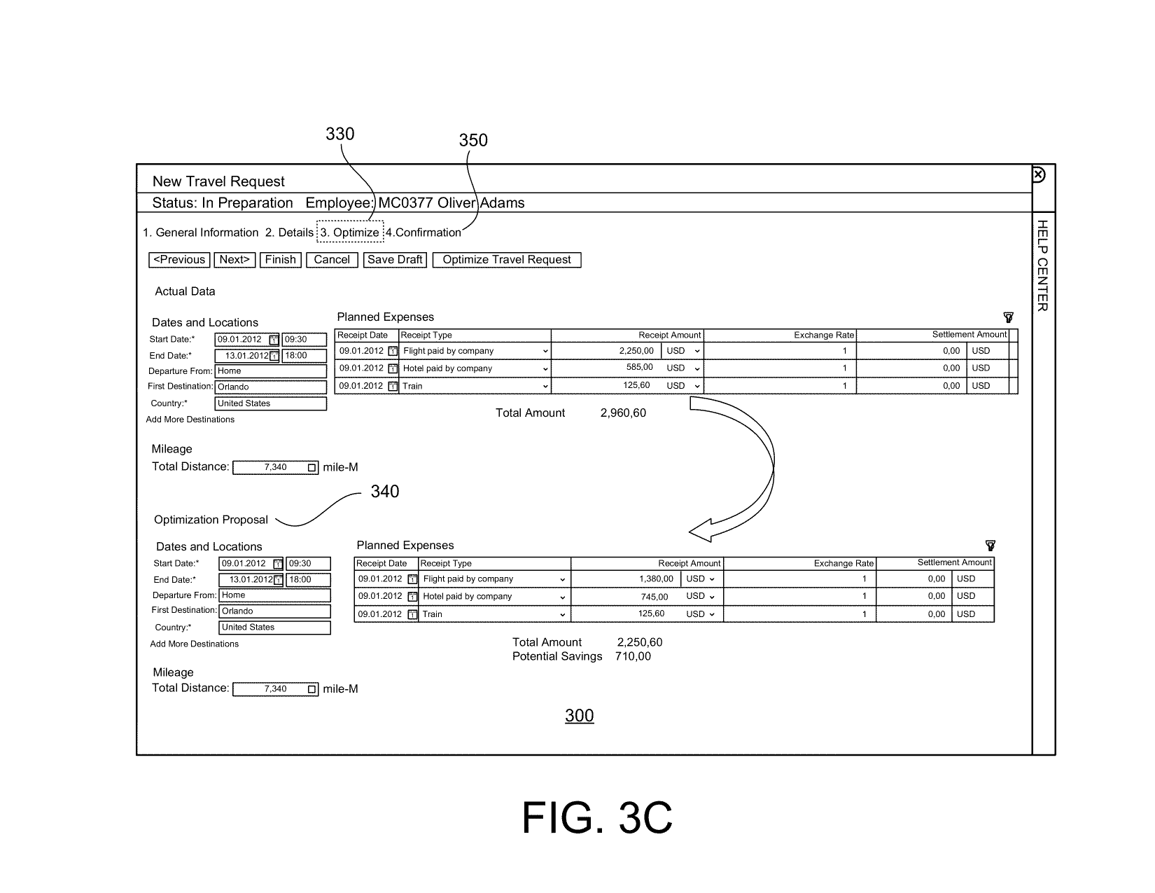

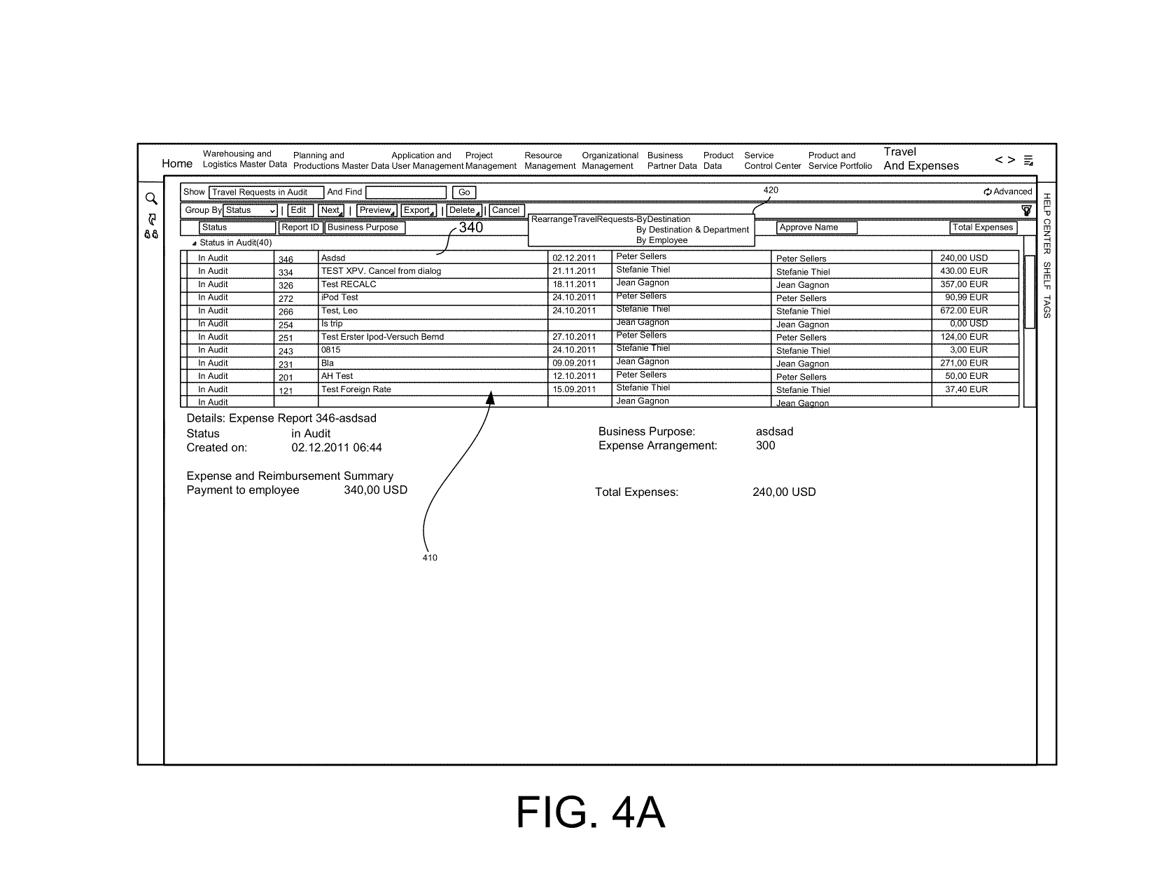

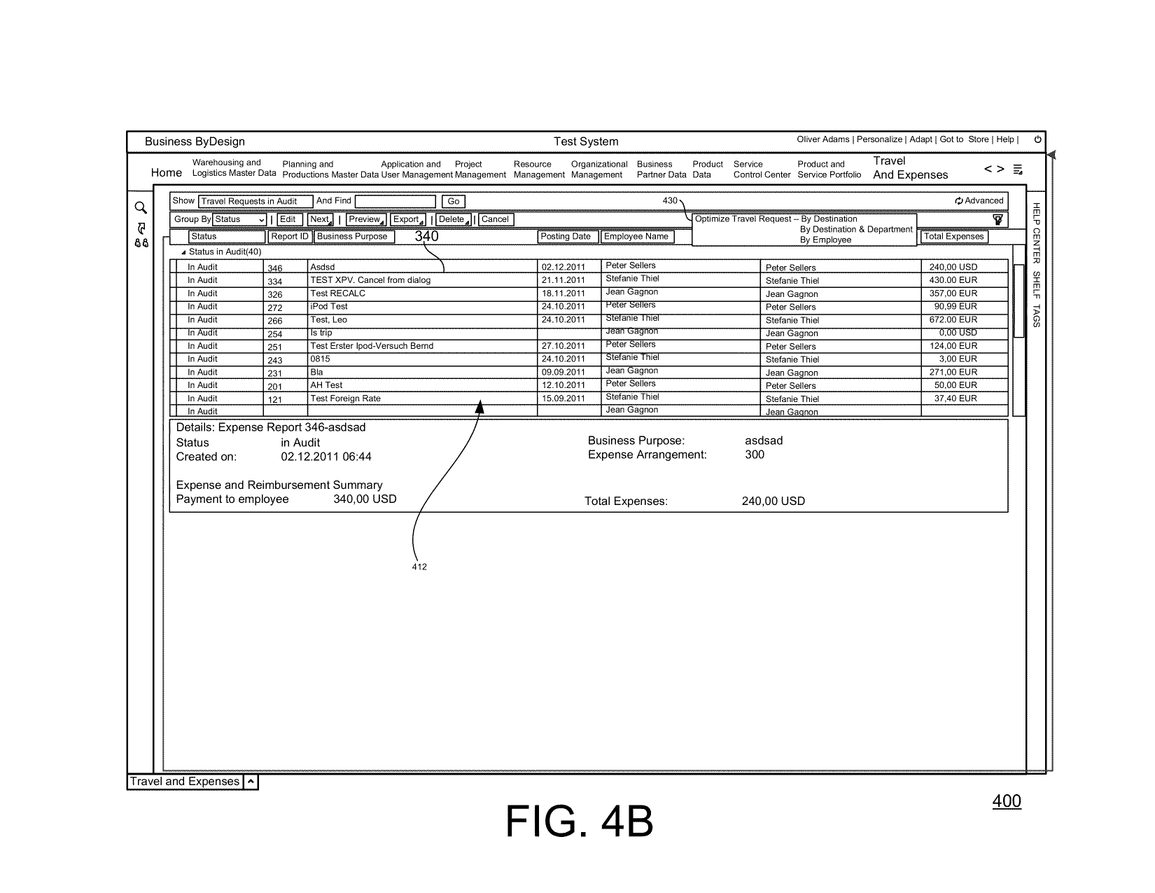

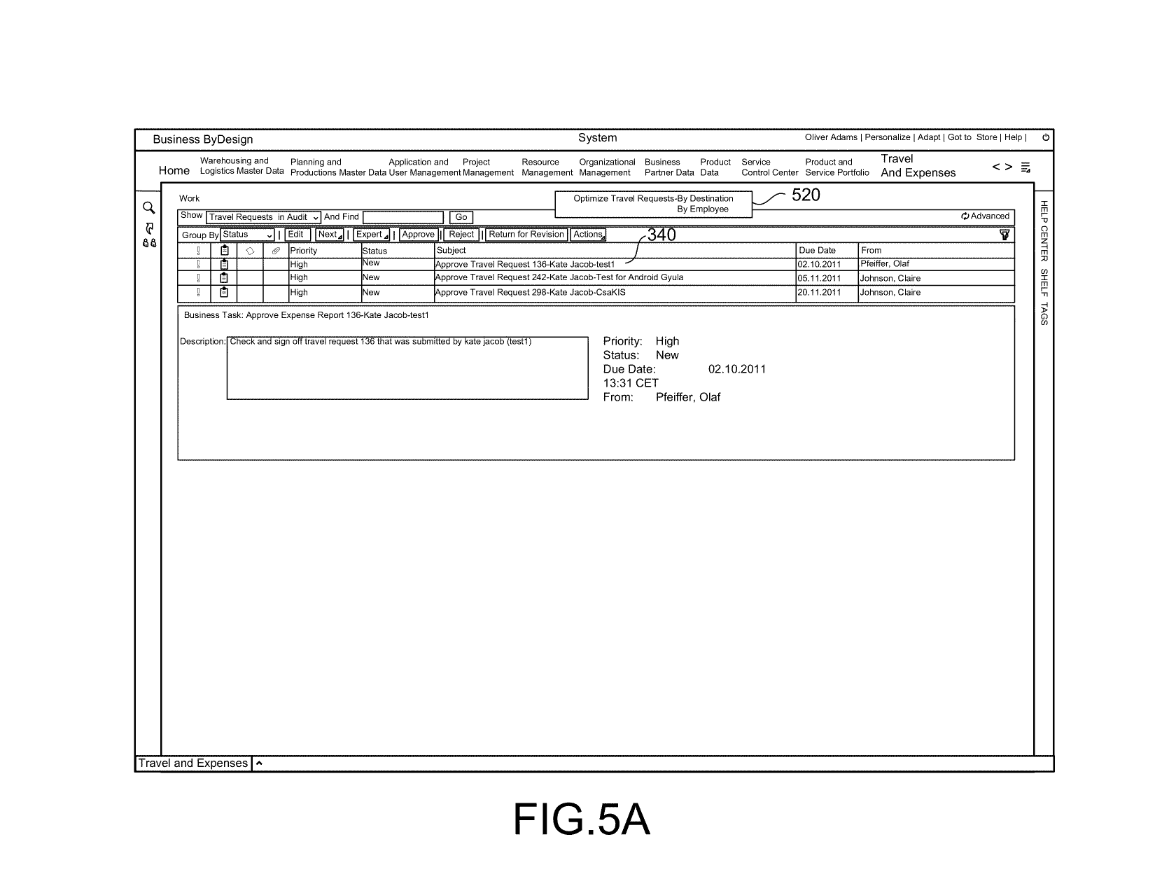

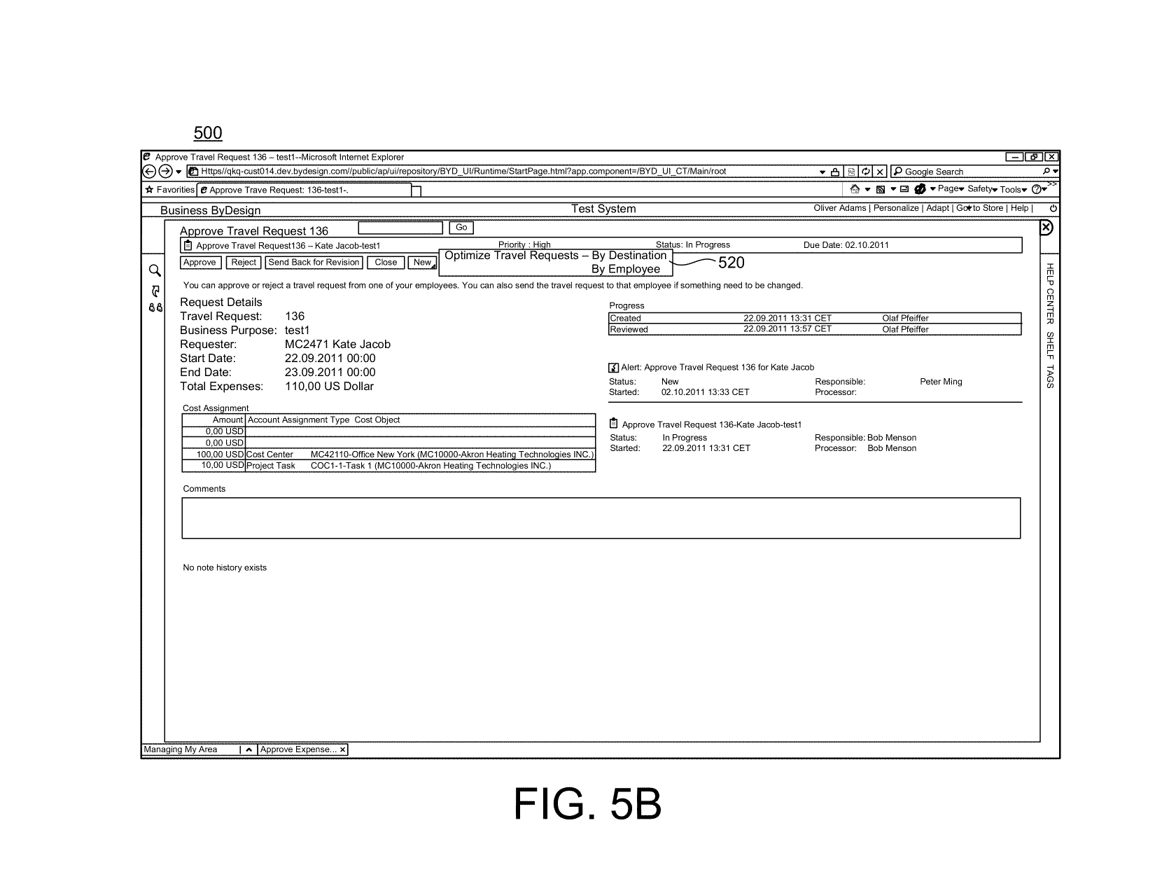

System 100 may include one or more interactive screens that are customized according to individual roles in the business organization. The interactive screens may be displayed, for example, on interfaces 114-118. FIGS. 3A-3C show an example screen 300, which may be displayed on interface 114, customized for an individual user. FIGS. 4A-4B show an example interactive screen 400, which may be displayed on interface 116, customized for a travel agent or a planner. Further, FIGS. 5A-5B show an example interactive screen 500, which may be displayed on interface 118, customized for a supervisor or manager.

Two example scenarios of system 100 uses are described below. In the first example scenario, a particular employee of an organization presents a travel request to system 100 for optimizing a travel plan for a trip. A travel agent reviews travel requests and resubmits the travel plan of the particular employee to system 100 for re-optimization. Further, a manager approves or rejects the particular employee's travel request which has been reviewed or re-optimized by the travel agent. In the second example scenario, a particular employee of an organization presents a travel request to system 100 for optimizing a travel plan for a trip. System 100 presents the particular employee's optimized travel plan directly to a manger for revision or approval.

### First Example Scenario

In the first example scenario, the particular employee may, for example, prepare a travel request for a business trip to Orlando, Fla. to visit a business facility. The employee may prepare the travel request, for example, on travel request screen 300 (FIG. 3A) displayed on interface 114. Under a general information tab 310, travel request screen 300 may have input areas or check boxes for the employee to enter general information and details about trip, for example, a trip purpose, a trip destination, a trip duration, a preferred airline or flight, a preferred hotel, a preferred means of transportation to and from airports, etc. If a train discount transportation card (e.g., a Bahn Card) is registered in the name of the employee, system 100 may automatically select “train” as the preferred means of transportation to the airport. Conversely, if a train discount transportation card (e.g., a Bahn Card) is not registered in the name of the employee, the travel request screen may present check boxes for choices (e.g., train, bus, taxi, airport shuttle, company car, etc.) that the employee may have for transportation to the airport.

Travel request screen 300 may also present a customization option to the employee to optionally create or modify a user profile, which may include pre-selected standard optimization rules for personalized travel plan preparation. The employee may also use search functionality 115 (FIG. 2) to fill in, or system 100 may automatically fill in, preliminary travel component details (e.g., airline flights) for the trip.

The employee may view general travel components (e.g., airline flights, hotel. etc.) for the trip, for example, under a “Details” functionality tab 320 on travel request screen 300 (FIG. 3B) and further details for each travel component via web links 322.

The employee may submit the travel request to system 100 for optimization using, for example, an “optimize” functionality tab 330 displayed on travel request screen 300 (FIG. 3C). In response, system 100 may automatically search for travel components for the trip. System 100 may, for example, search for airline flights to the destination (i.e., Orlando) along with price and seat availability information, hotel accommodations at the destination along with price and available room information, transportation to and from airports, etc.

System 100 may also search additional options for the travel components according to the user profile, which may include pre-selected standard optimization rules. System 100 may, for example, in an attempt to find cheaper flights according to the user profile, change the search for airline flights to include airlines other than the preferred airline, and change departure and/or arrival airports to include neighboring airports. System 100 may also, in an attempt to find cheaper flights according to the user profile, change the duration of the trip. If a cheaper flight is found for the changed duration of the trip, system 100 may automatically search for accommodation availability and pricing for the changed duration of the trip. System 100 may calculate the combined airline flight and accommodation costs to determine how much of the cost saving from the cheaper flight is offset by the increased cost of accommodations for the changed duration of the trip.

System 100 may also search additional options for each of the travel components automatically. For example, system 100 may enlarge a search radius for hotel accommodations. System 100 may display different hotel accommodation options and airport locations on a map to the employee. Further, for example, system 100 may extend its search for transportation to and from airports to include public transportation, which may be encouraged by the organization's travel policies over use of personal or rented automobiles.

System 100 may rank travel components for the trip by cost. Further, system 100 may automatically combine, for example, travel components that conform to the organizations' travel policies and rules, which also have the lowest combined total cost, to create an “optimized” travel plan. System 100 may present the optimized travel plan as an “optimization proposal” 340, for example, on travel request screen 300. The employee can accept optimization proposal 340 using, for example, a “confirm” functionality tab 350 on travel request screen 300 (FIG. 3C), in which case optimization proposal 340 may be recorded as the employee's optimized travel plan for the trip by system 100.

Further in the first example scenario, system 100 may include the employee's travel request/optimized travel plan 340, for example, in a list of travel requests 410, which may be presented to the travel agent on travel request audit screen 400 (FIGS. 4A and 4B) displayed on interface 116.

List of travel requests 410 displayed to the travel agent may also include travel requests for pending trips by other employees of the organization. The travel agent may select one or more of the travel requests in list 410 for review.

Travel request audit screen 400 may provide comparison rule selector functionality (e.g., 420, FIG. 4A) for selecting different comparison rules (e.g. by destination, by destination and department, by employee, etc.) for comparing the travel requests in list 410. Travel request audit screen 400 may also provide optimization selection functionality (e.g., 430, FIG. 4B) for re-optimization of an individual travel request or a group of travel requests (e.g. grouped by destination, by destination and department, by employee, etc.) in list 410.

The travel agent may, for example, select the comparison by destination rule for a particular employee's travel request using functionality 420. In response, system 100 may rearrange list 410 to present a rearranged overview list 412 (FIG. 4B) of all pending travel requests (i.e. have not yet been approved) for trips to the same destination (i.e. Florida) for about the same time period (e.g., ±a few days) as the particular employee's trip. Overview list 412 may include trips to the same destination by other employees across the organization and not merely employees belonging to a sub-entity (e.g., cost center, team or department) to which the particular employee belongs. In case, the travel agent selects the comparison by destination and department rule for the particular employee's travel request, system 100 may present an overview list of all pending travel requests for trips to the same destination by other employees belonging to the same department to which the particular employee belongs. In case, the travel agent selects the comparison by employee rule, system 100 may present an overview list of all pending travel requests for other trips by the particular employee that may be proximate in time (e.g., within a month) to the currently requested trip. It will be noted that the displayed overview lists of pending travel requests may include a display of cost information for each travel request for ease of visual comparison.

System 100 may further, automatically or upon travel agent initiation (e.g., via optimizing functionality 430, FIG. 4B), re-optimize the travel plan for the employee's travel request 340. System 100 may, for example, search for current information on other travel components and user profile customization options in the same or similar manner as described above with respect to optimization proposal 340 (FIG. 3C). This time around, system 100 may present an updated lowest total cost travel plan as a “re-optimization proposal” to the travel agent on a display screen.

The re-optimization proposal may show further cost savings over the original proposal. In which case, the travel agent may undertake to re-optimize travel requests for other pending employee trips to the same destination (e.g., list 412) to achieve further travel cost savings for the organization. System 100 may also allow the travel agent to re-optimize travel requests that have been previously approved to achieve further travel cost savings for the organization.

The travel agent may accept the “re-optimization proposal” (e.g., using a confirm button on the display screen) for the employee's travel request in which case the “re-optimization proposal” be recorded as the employee's updated travel plan for the trip by system 100. Next system 100, may automatically present the particular employee's travel request with the updated travel plan to a manager or supervisor for approval. The manager or supervisor may approve, reject, or return the updated travel plan for revision.

In the foregoing example scenario, system 100 may automatically alert the travel agent of possible or potential violations of the organization's travel policies and rules. For example, system 100 may alert the travel agent if more than one board member (or more than one manager in a critical area), in possible violation of company rules, have open travel requests for trips in a same time period, and are booked on a same airline flight or a same hotel. In response to the alert, the travel agent may seek an exception to the rules or change the travel plans (e.g., by booking other airline flights and/or hotels, etc.) to comply with the rules.

### Second Example Scenario

In the second example scenario, like in the first example scenario, a particular employee of an organization may present a travel request to system 100 for optimizing a travel plan for a trip, and may confirm system 100's optimization proposal as the employee's travel plan for the trip. System 100 may present the particular employee's optimized travel plan directly to a manger for review and approval, bypassing review or re-optimization by a travel agent. System 100 may, for example, include the employee's travel request/travel plan 340 in a list of travel requests 510 awaiting approval by the manager on a travel request approval tasks screen 500 (FIG. 5A) displayed on interface 118. List of travel requests 510 may also include travel requests for pending trips by other employees of the organization. Travel request approval tasks screen 500 may also include an optimization selector functionality (e.g., 520) to group and re-optimize travel requests 510 by different comparison rules or metrics (e.g. by destination, by destination and department, by employee, etc.).

The manager may select any of the travel requests in list 510 for comparison, review, or approval. The manager may, for example, select the particular employee's travel request 340 as shown in FIG. 5A. The manager may further, for example, using functionality 520 select the comparison by destination rule for the particular employee's travel request 340. In response, system 100 may present an overview list of all pending travel requests awaiting approval for trips to the same destination (e.g., Florida) for about the same time period (e.g., ±a few days) as the particular employee's trip. The overview list of all pending travel requests may include trips by employees in the sub-entity for which the manager is responsible. Conversely, if the manager selects the comparison by employee rule for the particular employee's travel request 340, system 100 may present an overview list of all pending travel requests for other trips by the particular employee which may be proximate in time to the currently requested trip.

In either case, system 100 may also automatically reprocess all the pending travel requests in the overview list and generate re-optimized travel plan proposals in the same or similar manner as described above with respect to the travel agent's role in the first example scenario. The manager may approve travel requests with the original travel plan proposals (e.g., optimization proposal 340) or the automatically re-optimized travel plans. The manager may approve travel requests one-by-one, or in groups (e.g. by destination, department or other organizational sub-entity).

In the foregoing second example scenario, system 100 may automatically alert the manger of potential violations of the organization's travel policies and rules. For example, system 100 may alert the manager if more than one executive or manager of the same area/department (or more than one executive or manager in a critical area), in possible violation of company rules, have open travel requests for trips in a same time period, and are booked on a same airline flight or in a same hotel. In response to the alert, the manager may seek an exception to the rules or change the travel plans (e.g., by booking other airline flights and/or hotels, etc.) as necessary to comply with the rules.

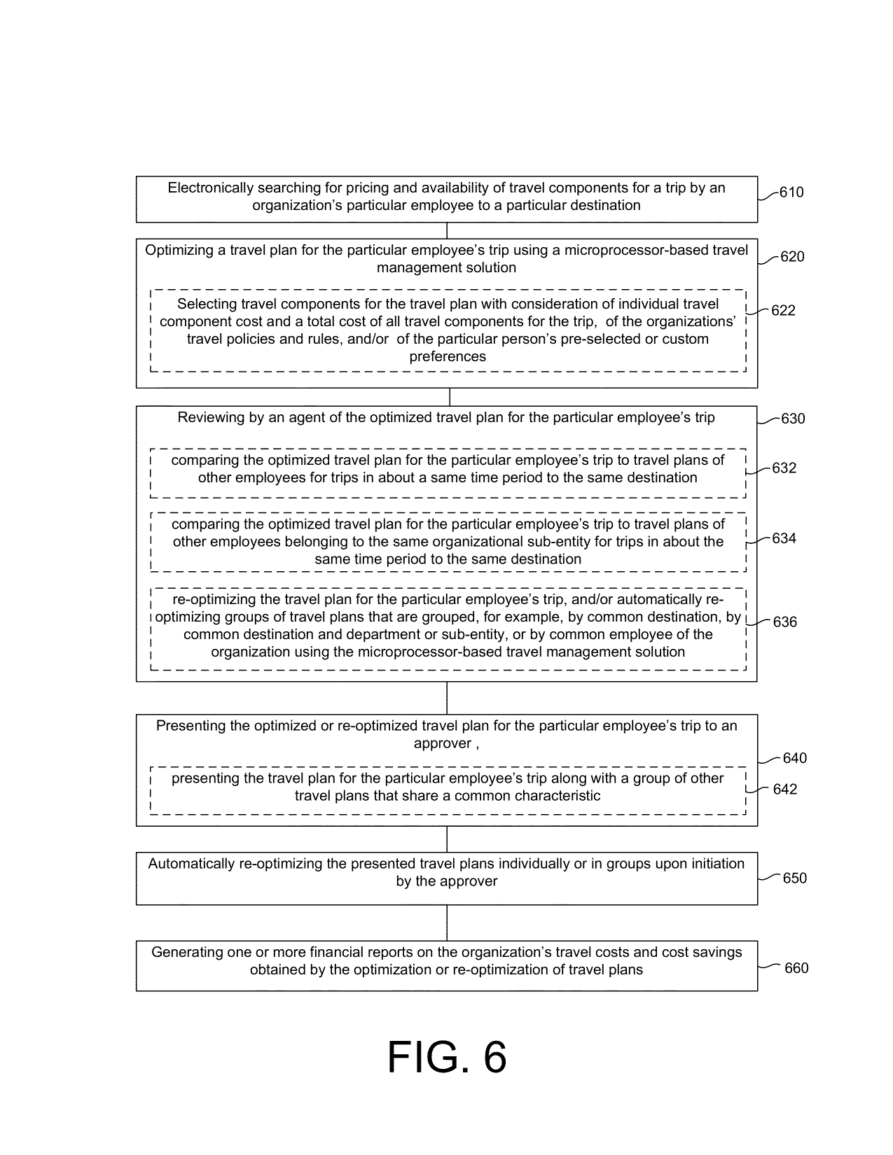

FIG. 6 shows an example method 600 for managing travel costs of an organization for trips by its personnel or employees, who may be organized in cost centers, teams, departments, divisions or other organizational sub-entities. Method 600 includes electronically searching for pricing and availability of travel components for a particular employee's trip to a particular destination (610), and optimizing a travel plan for the particular employee's trip (620) using a microprocessor-based travel management solution. In method 600, optimizing the travel plan for the particular employee's trip 620 may include selecting travel components with consideration of individual travel component cost and a total cost of all travel components for the trip, with consideration of the organizations' travel policies and rules, and/or with consideration of the particular person's pre-selected or custom preferences (622).

Method 600 further includes reviewing by an agent of the optimized travel plan for the particular employee's trip (630), which may include comparing the optimized travel plan for the particular employee's trip to travel plans of other employees for trips in about a same time period to the same destination (632), comparing the optimized travel plan for the particular employee's trip to travel plans of other employees belonging to the same organizational sub-entity for trips in about the same time period to the same destination (634), and comparing the optimized travel plan for the particular employee's trip to the particular employee's travel plans for other trips in a proximate time period.

Reviewing by the agent of the travel plan for the particular employee's trip 630, may also include re-optimizing the travel plan for the particular employee's trip, and/or automatically re-optimizing groups of travel plans that are grouped, for example, by common destination, by common destination and department or sub-entity, or by common employee of the organization (636).

Method 600 may further include presenting the optimized or re-optimized travel plan for the particular employee's trip to an approver for approval (640), which may include presenting the travel plan for the particular employee's trip along with a group of other travel plans that share a common characteristic (642). The common characteristic may for example, be a common destination, a common organizational sub-entity (e.g., cost center, team, department, division, etc.) and/or a common or same employee.

Method 600 may further include automatically re-optimizing the presented travel plans individually or in groups using the microprocessor-based travel management solution upon initiation by the approver (650).

Method 600 may additionally include generating one or more financial reports on the organization's travel costs and cost savings obtained by the optimization or re-optimization of travel plans (660). The financial reports may show costs and cost savings by travel component (e.g., transportation, accommodation, etc.). Further, the financial reports, which may be periodic (e.g., monthly, quarterly, annually, etc.) may breakdown costs and cost savings by organization level (e.g. cost center, department, division, etc.)

The various systems, apparatus or techniques described herein may be implemented in digital electronic circuitry, or in computer hardware, firmware, software, or in combinations of them. The systems, apparatus and techniques may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Methods may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems, apparatus or techniques may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A microprocessor-based system, comprising:
a travel plan optimizer hosted on a computer;
a repository of travel policies and rules of an organization;
a unit configured to obtain market data on travel components of a travel plan for a trip by a person of the organization,
wherein the travel plan optimizer is configured to:
in response to receiving a travel request for the trip by the person of the business organization,
optimize the travel plan for the trip by the person of the business organization by automatically selecting travel components with consideration of costs of individual travel components, a total cost of travel components and conformance of the travel components to the travel policies and rules of the organization.

2. The microprocessor-based system of claim 1, wherein the travel plan optimizer is configured to evaluate alternate modes of transportation, alternate modes of accommodation, alternate routes and alternate start and end dates for the trip for inclusion in the optimized travel plan.

3. The microprocessor-based system of claim 1, wherein the travel request optimizer is configured to group the trip by the person of the business organization with trips by other personnel of the organization to avail of group rates for services.

4. The microprocessor-based system of claim 1, further comprising:
a first interactive interface for receiving the travel request for the trip by the person of the business organization for processing by the travel plan optimizer; and
a second interactive interface for supervision of optimized travel plans by an agent of the business organization.

5. The microprocessor-based system of claim 4, further comprising a decision tool configured to provide a list of travel plans of organization personnel via the second interactive interface for approval to the agent of the business organization.

6. The microprocessor-based system of claim 5, wherein the decision tool includes functionality to initiate automatic re-optimization of a group of optimized travel plans.

7. The microprocessor-based system of claim 1, further comprising a financial reporting tool configured to generate financial reports showing cost savings realized with travel plan optimization by the system for different organizational sub-entities.

8. The microprocessor-based system of claim 1, further comprising a consistency checker reporting tool configured to generate financial reports showing cost savings realized by travel plan optimization by the system for different organizational sub-entities.

9. A method, comprising:
electronically searching for pricing and availability of travel components for a trip by a particular employee of an organization to a particular destination;
optimizing a travel plan for the particular employee's trip by selecting travel components for the trip using a microprocessor-based travel management solution;
presenting the optimized travel plan for the particular employee's trip for to an agent of the organization; and
after presenting, re-optimizing the travel plan for the particular employee's trip using current information on the travel components for the trip.

10. The method of claim 9, wherein optimizing the travel plan for the particular employee's trip by selecting travel components for the trip using the microprocessor-based travel management solution includes selecting travel components for the trip with consideration of individual travel component cost and a total cost of all travel components for the trip and with consideration of the organizations' travel policies and rules.

11. The method of claim 9, further comprising comparing the optimized travel plan for the particular employee's trip to travel plans of other employees for trips in about a same time period to the same destination.

12. The method of claim 9, further comprising comparing the optimized travel plan for the particular employee's trip to travel plans of other employees belonging to a same organizational sub-entity as the particular employee for trips in about the same time period to the same destination.

13. The method of claim 9, wherein re-optimizing the travel plan for the particular employee's trip using current information on the travel components for the trip further includes automatically re-optimizing one or more groups of travel plans that are grouped by common destination, by common destination and department or sub-entity, and by common employee of the organization.

14. The method of claim 9, further comprising presenting the optimized travel plan for the particular employee's trip to an approver along with a group of other travel plans that share a common characteristic with the optimized travel plan for the particular employee's trip.

15. The method of claim 14, further comprising automatically re-optimizing the presented travel plans individually or in groups using the microprocessor-based travel management solution upon initiation by the approver.

16. The method of claim 14, further comprising generating at least one financial report on the organization's travel costs and cost savings obtained by the optimization or re-optimization of travel plans.

17. A non-transitory computer readable medium, comprising instructions capable of being executed on a microprocessor, which instructions when executed:
electronically search for pricing and availability of travel components for a trip by a particular employee of an organization to a particular destination;
optimize a travel plan for the particular employee's trip by selecting travel components for the trip; and
upon review by an agent of the optimized travel plan for the particular employee's trip,
re-optimize the travel plan for the particular employee's trip using current information on the travel components for the trip.

18. The non-transitory computer readable medium of claim 17, wherein the instructions when executed optimize a travel plan for the particular employee's trip by selecting travel components for the trip with consideration of individual travel component cost and a total cost of all travel components for the trip and with consideration of the organizations' travel policies and rules.

19. The non-transitory computer readable medium of claim 17, wherein the instructions when executed further automatically re-optimize one or more groups of travel plans that are grouped by common destination, by common destination and department or sub-entity, and by common employee of the organization.

20. The non-transitory computer readable medium of claim 17, wherein the instructions when executed generate at least one financial report on the organization's travel costs and cost savings obtained by the optimization or re-optimization of travel plans.
